(19) United States
(12) Patent Application Publication
(10) Pub. No.: US 2019/0173880 A1
(43) Pub. Date: Jun. 6, 2019

(54) SECURE NODE MANAGEMENT USING SELECTIVE AUTHORIZATION ATTESTATION

(71) Applicant: Samsung Electronics Co., Ltd., Suwon-si (KR)

(72) Inventor: Madjid Nakhjiri, Los Gatos, CA (US)

(21) Appl. No.: 16/209,835

(22) Filed: Dec. 4, 2018

Related U.S. Application Data
(60) Provisional application No. 62/594,460, filed on Dec. 4, 2017.

(51) Int. Cl. H04L 29/06; H04L 12/66; G06F 9/4401; G06F 21/57

(52) U.S. Cl. CPC H04L 63/0884; H04L 12/66; H04L 63/029; G06F 9/4416; G06F 2221/033; H04L 63/0853; G06F 21/575; H04L 63/0876; H04L 63/10

(57) ABSTRACT

A method of authorizing a gateway device to communicate with a registration server on behalf of an end node device is presented. The method entails a server at the cloud receiving a registration request from the gateway device, generating a bootstrapping authorization blob (BAB) in response to the registration request, and transmitting the BAB to the gateway device. The BAB defines functions that the gateway device is authorized to perform, and may be a flag vector containing a list of flags, each of the flags indicating authorization for a specific function. The method presented herein provides a secure and reliable way for end node devices 40 to communicate with the cloud without the elaborate interfaces required by conventional standards such as LWM2M.

### CROSS-REFERENCE TO RELATED APPLICATION(S)

This application claims the benefit of U.S. Provisional Patent Application No. 62/594,460 filed on Dec. 4, 2017, the content of which is incorporated by reference herein.

### BACKGROUND

Application Programming Interface (API) access control to device resources (on cloud databases) are typically based on an OAuth token. Currently, there is much room for improvement with that access control scheme. For example, OAuth token scope is too coarse, and lacks security. Such token may be used as pre-shared key (PSK) for Transport Layer Security (TLS).

A token is acquired and stored based on availability of secure storage and public key infrastructure (PKI). Generally, end node devices are expected to be managed by a gateway device acting as an End Node Manager (ENM). However, neither the end node device nor the cloud knows about the gateway device's responsibility for the end node devices.

Device Management (DM) standards such as LWM2M are available for devices that are ultimately managed by cloud. However, LWM2M has an elaborate interface that is discouraging to use, requiring specific bootstrapping and registration interfaces to allow a DM server to handle specific clients. FIG. 5 depicts an example of an LWM2M interface. As shown, first, a bootstrapping happens between the gateway device and the bootstrap server of the cloud. Then, registration process happens between the gateway device and the DM server, followed by management and information reporting.

A simpler yet effective way of securely and reliably managing end node devices in a cloud database environment is desired.

### SUMMARY

In one aspect, the disclosure pertains to a method of authorizing a gateway device to communicate with a registration server on behalf of an end node device. The method entails receiving a registration request from the gateway device, generating a bootstrapping authorization blob (BAB) in response to the registration request, and transmitting the BAB to the gateway device. The BAB defines functions that the gateway device is authorized to perform, and may be a flag vector containing a list of flags, each of the flags indicating authorization for a specific function.

In another aspect, the disclosure pertains to a method of managing communication between an end node device and a cloud registration server, the method comprising registering with the cloud registration server and receiving a bootstrapping authorization blob (BAB) from the cloud registration server, the BAB providing attested authorizations for specific functions and for which end node device the specific functions are.

In yet another aspect, the disclosure pertains to a non-transitory computer-readable storage medium comprising instructions that, when executed, authorize a gateway device to communicate with a registration server on behalf of an end node device. This authorization is given by receiving a registration request from the gateway device, generating a bootstrapping authorization blob (BAB) in response to the request, and transmitting the BAB to the gateway device. The BAB defines functions that the gateway device is authorized to perform, the BAB being a flag vector containing a list of flags, each of the flags indicating authorization for a specific function.

In yet another aspect, the disclosure pertains to a system for secure node management wherein nodes communicate with a cloud. The system includes a cloud registration server including one or more computing devices, wherein the cloud registration server generates a bootstrapping authorization blob (BAB) defining functions that a gateway device is authorized to perform on behalf of select end nodes, and a gateway device receiving the BAB from the cloud registration server.

### DESCRIPTION OF THE DRAWINGS

FIG. 1 is a block diagram illustrating a communication system in accordance with an embodiment of the inventive concept.

FIG. 2 depicts an embodiment of Bootstrapping Authorization Blob (BAB) in detail.

FIG. 3 is a schematic diagram summarizing the tasks handled by an end node manager according to the ENMAP.

FIG. 4 depicts the backend-frontend integration of the system in accordance with the inventive concept.

FIG. 5 depicts the backend-frontend communication process in accordance with LWM2M standards.

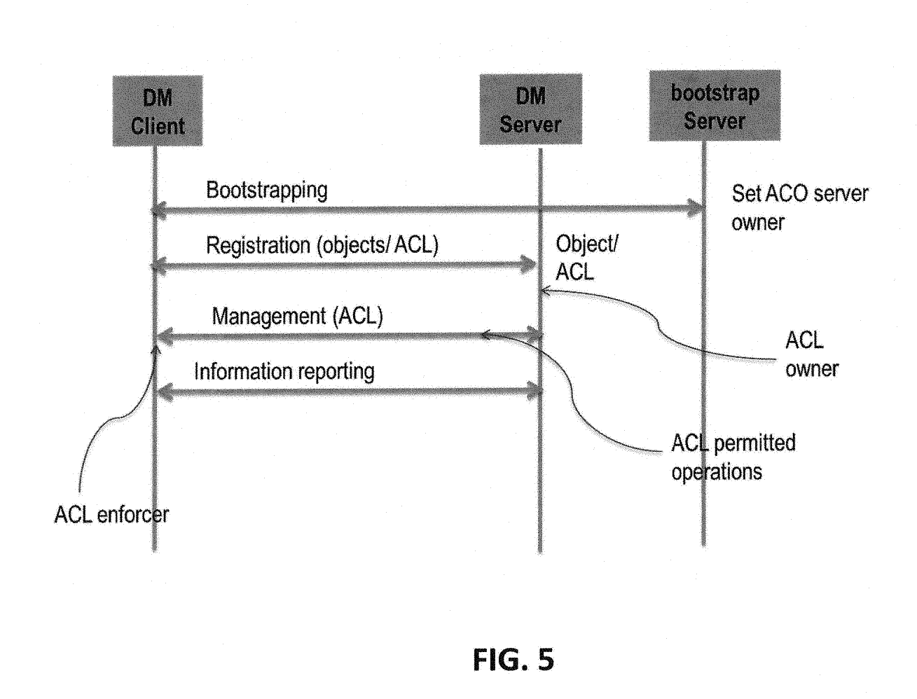

### DETAILED DESCRIPTION

The inventive concept disclosed herein relates to a method and apparatus for securely managing the communication between end node devices and cloud by using authorization attestations. The method and apparatus disclosed herein is applicable to the context of Internet of Things (IoT), which generally includes various end node devices (e.g., thermostat, light switches, coffee maker) communicating with the cloud over a network. However, an IoT environment is not a limitation of the concept disclosed herein.

Compared to known DM standards such as LWM2M, the method of the disclosure includes detailed authorization decisions in the cloud registration result. The scope of each token is more granular than in currently known systems, and each token may be specific to a service. With the technique disclosed here, the gateway device is granularly authorized to handle specific functions for end node devices that are incapable of performing those functions on their own, for example due to security or connectivity issues with the cloud. The method and apparatus of this disclosure enhance the trust between the gateway device and the end node devices through capability discovery. Each association between the gateway device and an end node device is recorded at cloud servers to allow network services (e.g., Device Management service, Over the Air service) to locate an end node device through the gateway device. The method and apparatus of this disclosure eliminates the need for specific bootstrap and registration interfaces that complicate standards such as LWM2M.

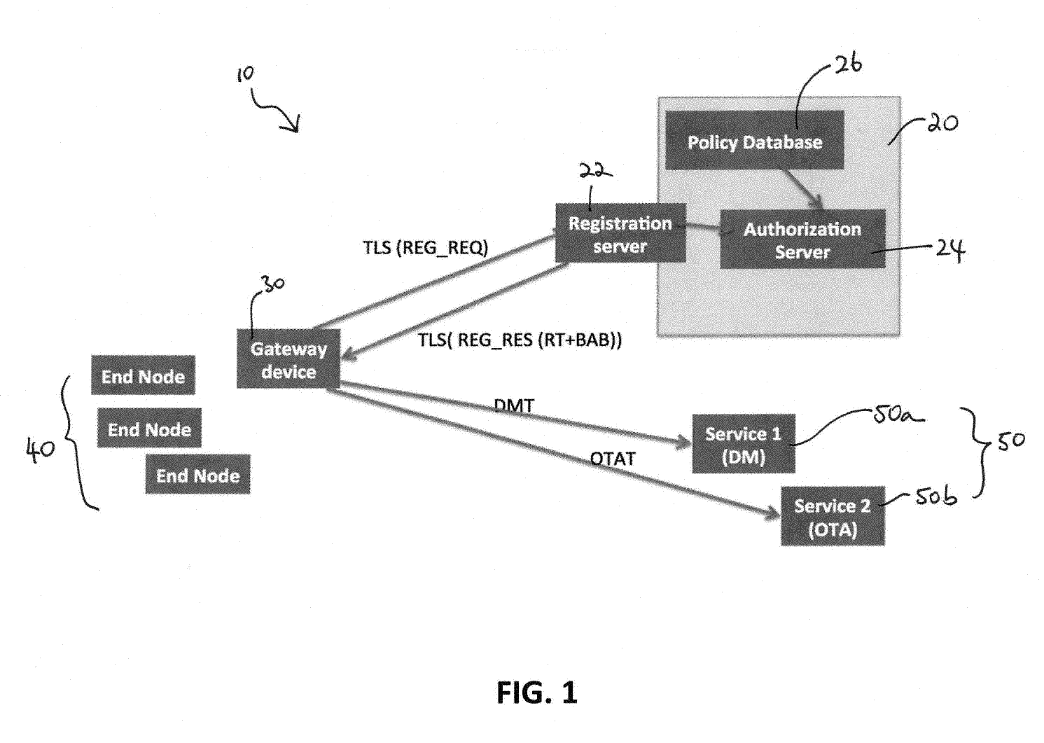

FIG. 1 is a block diagram illustrating a communication system 10 in accordance with an embodiment of the inventive concept. As shown, the communication system 10 includes the cloud 20, end node devices 40 that communicate with and are managed by the cloud 20, and a gateway device 30 that acts as an End Node Manager (ENM 30) that manages the communication between the end node devices 40 and the cloud 20. The end node devices 40 are any device that connects to the cloud 20, for example to use IoT services, and may be a television, light switch, toaster, etc. As used herein, an “end node device 40i” is any one of the end node devices 40. Each of the end node devices 40, the End Node Manager 30, and DM server 50a and OTA server 50b (the servers 50a and 50b are collectively referred to as network services 50) may include one or more computing devices. The cloud 20 has a registration server 22, which may also include one or more computing devices. The network services 50 may be generic to any type of cloud 20.

The end node devices 40, end node manager 30, the cloud 20, and the network services 50 communicate with each other through a network, which may be wired and/or wireless networks including but not limited to local area network (LAN), wide-area network (WAN), and/or a global network such as the Internet. The network may be any communication network that allows data exchange.

When one of the end node devices 40 wants to communicate with the cloud 20, it contacts the End Node Manager 30. In accordance with the inventive concept, an end node device 40i can reach the cloud through the registration server 22, DM server 50a, or the OTA server 50b but relies on the trusted End Node Manager 30 to get in contact with the cloud. The End Node Manager 30 sends a registration request TLS(REG_REQ) to the registration server 22, for example using mutually authenticated certificates of transport security layer (TLS) protocol. In response, the registration server determines what authorizations the end node manager 30 should have by accessing the authorization server 24 and policy database 26. The registration server then transmits a response TLS (REG_RES (RT+BAB)) to the ENM 30 using a secure protocol such as TLS. The response contains a Bootstrapping Authorization Blob (BAB), which prescribes exactly what functions the ENM 30 may or may not perform, and with which end node device. In some embodiments, the response also contains a Registration Token (RT) indicating that the particular ENM 30 is registered with the cloud 20.

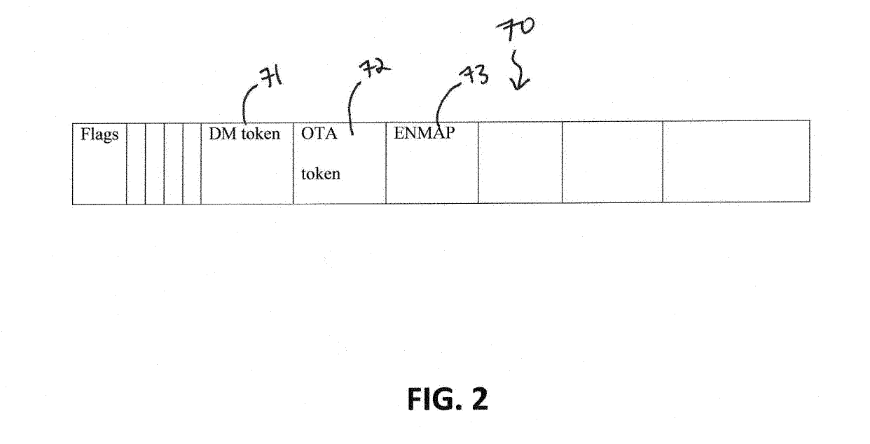

FIG. 2 depicts an example of a BAB 70 in more detail. The BAB provides attested (verifiable) authorization to the gateway device (ENM 30) and other services that the gateway is authorized to access. The contents of BAB 70 require integrity protection.

As shown, BAB 70 contains a list of flags for specific functions, such as a Device Management (DM) authorization flag 71, an Over the Air (OTA) authorization flag 72, and an End Node Management Authorization Policy flag (ENMAP) 73. In an example embodiment where the BAB 70 is a flag vector, each of DM authorization flag 71 and OTA authorization flag 72 may be one-bit (0 or 1). For example, if DM authorization flag 71 is set to “1,” that would indicate that a DM Token (DMT) is included in the BAB and the end node manager 30 is authorized to receive DM service itself or nodes attached to the DM server 50a (e.g., end node devices 40). As shown in FIG. 1, the end node manager communicates with the DM server 50a using the DMT, which includes DMT integration protection bits. On the other hand, the DM authorization flag 71 being set to “0” would indicate that the end node manager 30 is not authorized to receive DM service.

Similarly, if OTA authorization flag 72 is set to “1,” that would indicate that the OTA Token (OTAT) is included in the BAB and the end node manager 30 is authorized to receive OTA service for itself or nodes attached to it (e.g., end node devices 40). As shown in FIG. 1, the end node manager 30 communicates with the OTA service 50b using the OTAT, which includes the OTAT integration protection bits. The OTA authorization flag 72 being set to “0” would indicate that the end node manager 30 is not authorized to receive OTA service. The DMT and OTAT are used by the end node manager 30 to attest it has been registered with the Registration Server 22 and is separate from the requirement for the end node manager 30 to establish a TLS with the DM and OTA servers 50.

The ENMAP flag 73 indicates which end node management functions the end node manager 30 is authorized to perform with corresponding servers on behalf of specific end nodes 40 it is managing.

In one embodiment, the BAB is part of the Registration Token (RT). This may be practical where payload size is not an issue with the bearer protocol (e.g., HTTP or COAP).

All tokens are integrity-protected to avoid unwanted tampering. Depending on the capability of parties to make use of the tokens (e.g., the DM server 50a) and the capability of the system 100 in using PKI, there are methods that may be used. For example, when PKI is in place and there is no confidentiality requirement for the token contents (e.g., URIs), the issuing server, which in this case is the registration server 22, simply uses a private signing key corresponding to its certificates and all other servers are able to verify the integrity and authenticity of the token independently (without having to consult the issuing server). When PKI is not in place or there is confidentiality requirement for the token contents, the issuing server can use a symmetric token encryption key (TKEK) that is not shared with any outside parties. Any party that needs to rely on a token sends the token back to the issuing server for verification.

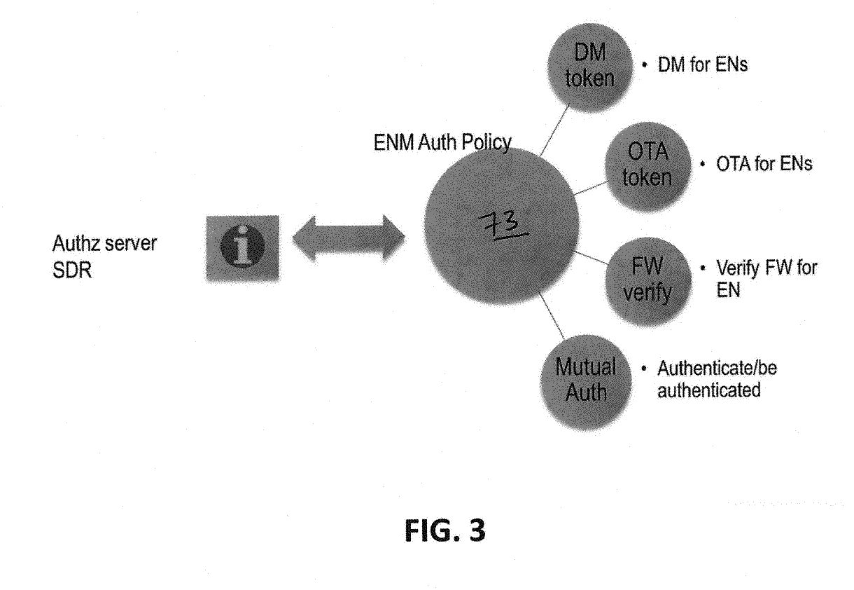

FIG. 3 is a diagram summarizing the tasks handled by an ENM 30 according to the ENMAP. As shown, the ENMAP 73 is generated by the cloud server (e.g., registration server 22). The ENMAP 73 includes a DM token, an OTA token, a firmware verification or integrity check function, and mutual authentication function.

In one embodiment, ENMAP 73 may be implemented as a 2-byte flag vector. The bits may be as follows:
Bit 0 (most significant bit) indicates if the End Node Manager 30 is allowed to act as the end node manager on behalf of a number of end node devices 40 for the registration server 22.
Bit 1 indicates if the End Node Manger 30 is allowed to act as the end node manager on behalf of DM server 50a and health monitoring devices.
Bit 2 indicates if the End Node Manager 30 is allowed to act as the end node manager on behalf of OTA server 50b.
Bit 3 indicates if the End Node Manager 30 is allowed to perform secure boot or firmware integrity checks (that the ENM 30 is the entity that performs verifications for images to be installed on the end node devices attached to the ENM 30).
Bit 4 indicates if the End Node Manager 30 requires end node device authentication as part of a secure link establishment between the end node devices 40 and the End Node Manager 30. The secure link may be used for audit recording in regulatory controlled verticals (e.g., HIPAA) where data path shall be controlled.
Bit 5 indicates if the End Node Manager 30 shall authenticate to the end node devices 40 and convey that it can take on the end node manager function.
Bits 6-10 contain flags showing if authentication methods are supported (and possibly security policy stating which method is required/preferred) if Bit 4 is set. Methods may include end node device QR scanning, NFC, BLE, etc.
Bits 11-15 may be reserved.

In some embodiments, End Node Manager 30 may present the following information to the end node devices 40:
An ID for the end node manager (which was used to obtain the registration token)
Registration Server ID
A validity period or expiration time (such that the authority expires if DM server 50a loses touch with the End Node Manager 30 or suspects misbehavior)
Information regarding ENMAP

The DMT and OTAT are similar in nature and construct. They may include:
An ID for the end node manager (which was used to obtain the registration token; in some cases, the ENM device identity is inside the ENM certificate)
End Node Manager registration ID (e.g., a UUID assigned by the Registration Server as a result of registration; often found in registration token)
Registration Server ID
Optionally, a validation period that can expire if DM server 50a loses touch with ENM 30 or suspects misbehavior
ID for DM server 50a (e.g., from DM server certificate or DM server URI for the ENM to contact)
End Node DM flag or End Node OTM flag, when clear (e.g., “0”), the token is for End Node Management device management authorization only. When set (e.g., “1”), the token may be used by End Node Manager 30 for device management functions pertaining to end node devices 40 attached to the End Node Manager 30.
“End Node ID list present” flag is present if End Node DM flag or EN OTA flag is set, i.e. the End Node Manager 30 is authorized to perform DM or OTA for end node devices 40. When the “End Node ID list present” flag is present and clear (e.g., “0”), it means there will not be a following “EN ID list” field. This scenario happens when the End Node Manager 30 is registering and not aware of any end node devices 40 that will be attaching in the future. When the “End Node ID list present” flag is present and set (e.g., “1”), there will be an EN ID list” field following. This scenario happens when the End Node manager 30 has already registered and is managing one or more end node devices 40, and thus may be specifically authorized by the registration server to perform DM or OTA for the specifically-listed end node devices 40.
The EN ID list, as described above, is present when EN DM flag (or EN OTA flag) and “EN ID list present flag” are both set. This field provides an end node device ID list generated by the registration server (as would be stored in the database of registered devices).
DMT or OTAT integrity protection bits as explained above.

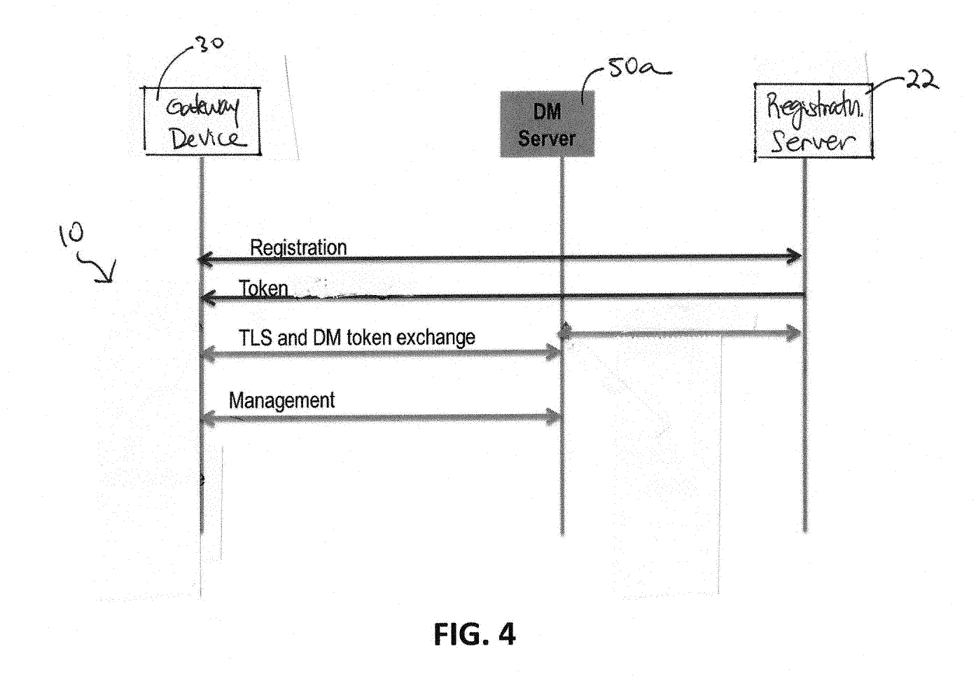

FIG. 4 depicts the backend-frontend integration of the system 10. The End Node Manager 30 registers with the Registration Server 22. In return, it receives a Registration token and a BAB. The End Node Manager 30 verifies the BAB from Registration Server 22 using the Registration Server certificate, and checks which flags of the BAB are present and set. The ENM 30 then exchanges tokens with the DM server 50a and the OTA server 50b and manages them. The DM server 50a and the registration server 22 may be part of the same cloud, although this is not a limitation of the inventive concept.

If the ENMAP flag authorizes the End Node Manager 30 to act as the manager of end node devices 40, the End Node Manager 30 starts interacting with the end node devices 40. This interaction begins with a discovery process. Depending on the LAN mechanism used between the End Node Manager 30 and the end node devices 40, an exchange may take place. In one embodiment, as part of the initial discovery process, the End Node Manager 30 and the end node devices 40 may exchange a set of properties described below. Some of these properties may be exchanged only after the secure connection is established, to provide privacy or additional security. An end node device security capabilities (ENSC) blob may be added to device type definitions (e.g., manifest) with the service provider.
End node devices address/device ID (pseudo identity may be used for privacy)
End node device Hardware security characteristics flag vector includes 2 bits for declared security level (if available), 2 bits for ability to verify cryptographic signatures, 1 bit for availability of certificates, and 1 bit for ability to perform TLS/DTLS. Secure boot and secure firmware verifications support may be available in hardware (and security level).
End node device functional characteristics flag vector includes 1 bit for ability to perform registration with the Registration Server 22, 1 bit to perform OTA, and 1 bit to perform DM. If any of those bits is clear (e.g., “0”), it indicates the desire to offload those functions to the End Node Manager 30.

Sometimes, the End Node Manager 30 may advertise its security and end node management capabilities to the end nodes in the form of ENM security capability (ENMSC) blob, which may include the end node device ID (or registered UUID) and End Node Manager capability advertisement (e.g., ability to do firmware integrity verification, DM/OTA on behalf of the end node device). If the end node device does not have verification capabilities (e.g., to verify a signature), or to protect sensitive fields in BAB, the End Node Manager 30 may include a subset of BAB capabilities in the capability advertisement to the end node devices 40.

After the End Node Manager 30 establishes a secure connection using whatever LAN security (tread/BLE) mechanism is available, End Node Manager 30 will use an out-of-band authentication mechanism in case the end node can engage in an unauthenticated key exchange such as ECDH. After secure connection is established, the End Node Manager 30 presents the BAB to the end node devices 40. If the end node device 40i has capability, it verifies the BAB integrity protection (signature) and sends confirmation to End Node Manager 30 that it is willing to accept the End Node Manager 30 as its end node manager.

The End Node Manager 30 performs registration of the end node device with the Registration Server 22 and in the messaging, may include end node device confirmation for providence/audit records. When the end node device registration is completed by the Registration Server 22, any device ID assigned by Registration Server 22 to the end node device 40i as part of the registration process is bound to the device identity that the end node device uses within the LAN between the end node device 40i and the End Node Manager 30, and the end node device ID list can be added to any OTA or DM tokens sent to the End Node Manager 30.

Once the Registration Server 22 receives the registration log/result for each end node device from the ENM 30, the Registration Server 22 creates an end node device-ENM binding (ENMB) token/entry, which includes the end node device ID (provided by the Registration Server 22), ENM device ID (provided by Registration Server 22 or from a certificate recognized by the Registration Server 22), and optionally, ENMAP. The ENMB token/entry allows the DM server 50a and/or OTA server 50b to know how to locate each one of the end node devices 40 and provide DM or OTA services through the gateway device that they are registered with. The ENMB token may be signed by the Registration Server 22 and sent to End Node Manager 30, DM server and OTA server as well as being kept securely at the Registration Server 22.

After the DM and OTA servers receive the ENMB, they can update their firewalls (or access data base) to accept DM/OTA messaging from the End Node Manager 30 regarding any of the end node devices that are bound to the End Node Manager 30. The End Node Manager 30 will update its own firewall (or URL) with the URL for the DM and/or OTA servers 50, to avoid DM and/or OTA server spoofing. This way, the End Node Manager 30 can check the certificates it receives from the DM and/or OTA servers against the DM and/or OTA tokens received from the Registration Server 22.

The method and apparatus presented herein provides a secure and reliable way for end node devices 40 to communicate with the cloud without the elaborate interfaces required by conventional standards such as LWM2M.

While the embodiments are described in terms of a method or technique, it should be understood that the disclosure may also cover an article of manufacture that includes a non-transitory computer readable medium on which computer-readable instructions for carrying out embodiments of the method are stored. The computer readable medium may include, for example, semiconductor, magnetic, opto-magnetic, optical, or other forms of computer readable medium for storing computer readable code. Further, the disclosure may also cover apparatuses for practicing embodiments of the inventive concept disclosed herein. Such apparatus may include circuits, dedicated and/or programmable, to carry out operations pertaining to embodiments.

Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to the embodiments.

It should be understood that the inventive concept can be practiced with modification and alteration within the spirit and scope of the disclosure. The description is not intended to be exhaustive or to limit the inventive concept to the precise form disclosed.

What is claimed is:

1. A method of authorizing a gateway device to communicate with a registration server on behalf of an end node device, the method comprising:
receiving a registration request from the gateway device;
in response to the registration request, generating a bootstrapping authorization blob (BAB) defining functions that the gateway device is authorized to perform, the BAB being a flag vector containing a list of flags, each of the flags indicating authorization for a specific function; and
transmitting the BAB to the gateway device.

2. The method of claim 1, wherein the BAB contains at least one of a Device Management (DM) authorization flag and an Over the Air (OTA) authorization flag, the DM authorization flag and the OTA authorization flag indicating whether the gateway device is authorized to receive DM service and OTA service, respectively, on behalf of the end node device.

3. The method of claim 1, wherein the BAB contains End Node Manager Authorization Policy (ENMAP) to indicate the end node device management functions that the gateway device is authorized to perform with a predefined server on behalf of pre-identified end node devices.

4. The method of claim 3, wherein the ENMAP is a 2-byte flag vector with a first flag indicating if the gateway device is allowed to act on behalf of the end node device with respect to the registration server, a second flag indicating if the gateway device is allowed to act on behalf of the end node device with respect to the DM server, and a third flag indicating if the gateway device is allowed to act on behalf of the end node device with respect to the OTA server.

5. The method of claim 4, wherein the DM flag dictates whether a DM token (DMT) is generated to inform a DM server that the gateway device is registered with the registration server, and wherein the OTA flag dictates whether an OTA token (OTAT) is generated to inform an OTA server that the gateway device is registered with the registration server.

6. The method of claim 5, wherein each of the DMT and the OTAT contains one or more of: a gateway device identification code, a gateway device registration code, a validation period, a DM/OTA server ID, and an end node device DM/OTA flag that indicates whether the gateway device manages functions for the end node device.

7. The method of claim 6, wherein each of the DMT and the OTAT contains an end node device ID list indicating end node devices for which the gateway device is authorized to perform DM or OTA by the registration server.

8. The method of claim 3, wherein the ENMAP is a 2-byte flag vector with a flag indicating if the gateway device is allowed to perform firmware integrity checks for the end node device, including verifications for images to be installed on the end node device.

9. The method of claim 3, wherein the ENMAP is a 2-byte flag vector with a flag indicating if the gateway device requires end node device authentication to establish a secure link between the gateway device and the end node device.

10. The method of claim 3 further comprising presenting the ENMAP to the end node device along with one or more of: an identification code for the gate device, an identification code for the registration server, and a validity period for the ENMAP.

11. The method of claim 1 further comprising a Registration Token generated by the registration server and transmitted to the gateway device to indicate that the gateway device is registered with the registration server.

12. A method of managing communication between an end node device and a cloud registration server, the method comprising registering with the cloud registration server and receiving a bootstrapping authorization blob (BAB) from the cloud registration server, the BAB defining specific functions that can be managed on behalf of the end node device.

13. The method of claim 12, wherein the BAB contains at least one of a Device Management (DM) authorization flag and an Over the Air (OTA) authorization flag, the DM authorization flag and the OTA authorization flag indicating permission to communicate with a DM server and an OTA server on behalf of the end node device.

14. The method of claim 13, wherein the BAB contains End Node Manager Authorization Policy (ENMAP) with a first flag indicating if the gateway device is allowed to act on behalf of the end node device with respect to the registration server, a second flag indicating if the gateway device is allowed to act on behalf of the end node device with respect to the DM server, and an OTA flag indicating if the gateway device is allowed to act on behalf of the end node device with respect to the OTA server.

15. The method of claim 12 further comprising receiving an end node device security capabilities (ENSC) blob that provides, for the end node device, one or more of security level, secure storage availability, ability to verify cryptographic signatures, certificate availability, ability to perform TLS/DTLS, and availability of secure boot and secure firmware verifications support.

16. The method of claim 12 further comprising:
registering the end node device with the cloud registration server;
receiving an end node device identification code from the cloud registration server;
receiving DM token (DMT) and OTA token (OTAT); and
checking for the end node device identification code in the DMT and the OTAT to determine whether to communicate with the DM server and the OTA server on behalf of the end node device.

17. A non-transitory computer-readable storage medium comprising instructions that, when executed, authorize a gateway device to communicate with a registration server on behalf of an end node device by:
receiving a registration request from the gateway device;
in response to the registration request, generating a bootstrapping authorization blob (BAB) defining functions that the gateway device is authorized to perform, the BAB being a flag vector containing a list of flags, each of the flags indicating authorization for a specific function; and
transmitting the BAB to the gateway device.

18. The non-transitory computer-readable storage medium of claim 17, wherein the BAB contains End Node Manager Authorization Policy (ENMAP) that specifically defines functions the gateway device is authorized to perform on behalf of the end node device, the functions being one or more of: if the gateway device is authorized to act on behalf of the end node device with respect to the registration server, if the gateway device is authorized to act on behalf of the end node device with respect to a DM server, if the gateway device is authorized to act on behalf of the end node device with respect to an OTA server, and an end node device ID list indicating end node devices to which authorization applies.
